(19) United States
(12) Patent Application Publication
(10) Pub. No.: US 2019/0043115 A1
(43) Pub. Date: Feb. 7, 2019

(54) MACHINE LEARNING TOOL

(71) Applicants: Thomas Purves, San Francisco, CA (US); John Rhidian, Belfast (GB)

(72) Inventors: Thomas Purves, San Francisco, CA (US); John Rhidian, Belfast (GB)

(21) Appl. No.: 15/666,734

(22) Filed: Aug. 2, 2017

(51) Int. Cl. G06Q 30/06; G06N 3/00; G06F 17/30; G06Q 30/02; G06F 7/58; G06N 99/00; G06N 5/04; G06Q 20/10

(52) U.S. Cl. CPC G06Q 30/0633; G06N 3/006; G06F 17/30312; G06Q 30/0201; G06Q 20/102; G06Q 30/0239; G06N 99/005; G06N 5/04; G06F 7/588

(57) ABSTRACT

A machine learning engine dynamically reweights input factors as user outcomes are observed and compared to various offers and incentives provided to a large sampling of users. Further, post-selection purchase flows may be optimized by an artificial intelligence (AI) engine to dynamically generate purchase flows that are based on real time data and user segmentation. The AI engine may selectively introduce random variations to small populations to provide feedback for optimizing solutions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Merchants strive to offer consumers incentives that will increase purchase volume and value, build loyalty, and create excitement about their brands. There are an almost unlimited variety of customer characteristics that can be measured for analyzing purchasing behavior. There are an almost equal number of incentives that can be presented to a consumer when attempting to build brand loyalty and affect purchasing habits. However, offering too many incentives can dilute the effect or even drive the consumer away through too many messages. Selecting incentives appropriate to a particular desired behavior has proven to be difficult.

### SUMMARY

In an embodiment, a machine learning engine analyzes in real time the behavior of a user who is using a website in order to identify areas for affecting the user's behavior while using the website. An artificial intelligence (AI) engine is used to make real time updates to the operation of the website to provide offers and alternate processing on an individual basis using not only current purchasing behavior but also time on the site, social media interactions, etc. The machine learning engine analyzes the user behavior based on training using records from previous shopping experiences of a plurality of users resulting in a recognized patterns and corresponding expected outcomes. These patterns may include various kinds of segmentation of the site visitors that may help predict behavior patterns including geographic location, mobile vs. laptop/desktop users, time of day, etc., to aid in selection of effective incentives. For example, patterns may emerge that indicate not only how to segment site visitors, such as UK/mobile phone/clothing shoppers, but also what characteristics of the shopping and checkout experience result in better conversions to actual sales. The AI engine may use this data from the machine learning engine and implement changes to the user experience that are predicted to move the user to a more desirable outcome for the merchant or to have a more satisfying interaction with the website.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a block diagram of a system for real time modification of a website for ecommerce flow optimization;

FIG. 2 is a block diagram of an alternate embodiment of a system for real time modification of a website for ecommerce flow optimization;

FIG. 3 is a block diagram illustrating an exemplary platform for generating real time updates for modification of a website;

FIG. 4 is a block diagram of a server and memory hosting artificial intelligence and machine learning engines;

FIG. 5 is an illustration of one embodiment of a machine learning engine;

FIG. 6 is an illustration of another embodiment of a machine learning engine; and

FIG. 7 is a flowchart of a method of performing real time modification of a website.

### DETAILED DESCRIPTION

A person (that is, a shopper or other site visitor) interacting with a website, particularly a first time visitor, may be encouraged or discouraged by various aspects of the shopping experience. A merchant may hope that the user will sign up for a newsletter or other on-line messaging, recommend a friend, post a “like” to social media, and purchase an extended warranty for a newly acquired item, as well as return to the website frequently. The shopper, however, may become discouraged or even irritated by a seemingly endless stream of offers and suggestions resulting in abandoned sessions, abandoned carts, or even avoiding return visits. Similarly, the payment process may affect a shopper's perception of the shopping experience and the order and presentation of cart and payment options may determine whether a shopper completes a purchase or abandons the session.

Striking a balance between making offers and processes that appeal to the user vs. overwhelming the user with unwanted messages is difficult. The ability to observe a large number of shopping sessions over multiple merchant websites allows the use of artificial intelligence to characterize shopping experiences based on diverse session characteristics. The characterization can then be used to alter the shopping experience to tailor the session to increase desired outcomes. Some observable characteristics and modifications to the session are detailed below.

In order to optimize the user experience of a user interacting with website, a combination of machine learning and generalized artificial intelligence may be used to evaluate and update, in real time, a particular user's experience by ecommerce flow optimization. The machine learning engine may be trained to recognize patterns in a website interaction resulting in changes to the shopping experience that are likely to affect a more positive outcome both for the user and for the merchant.

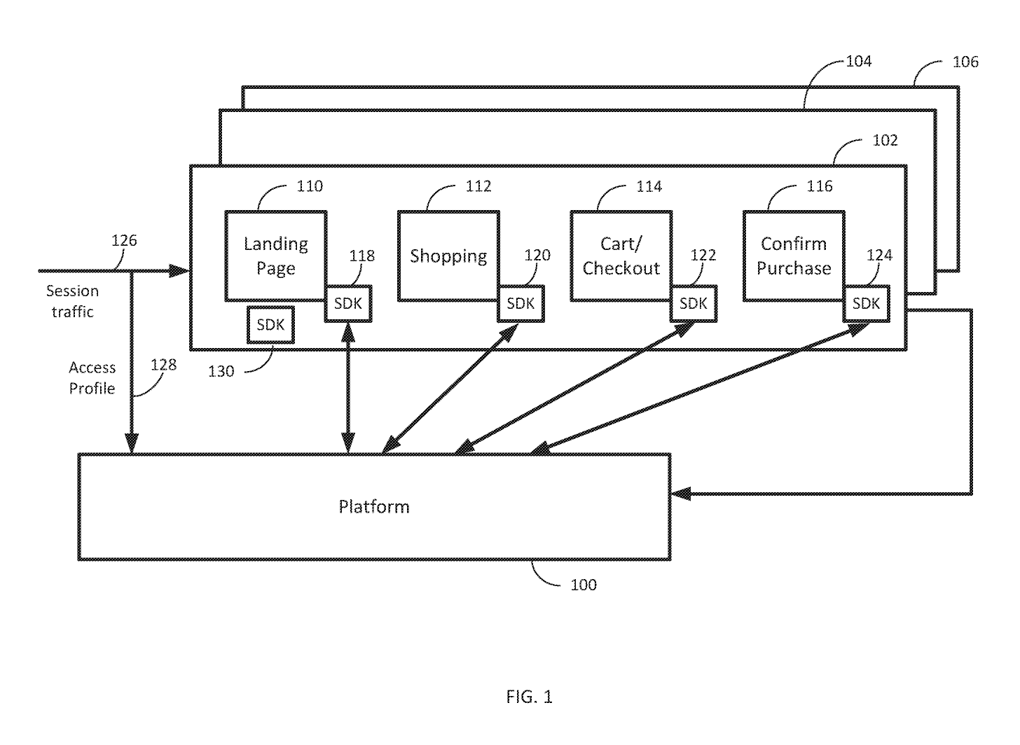

Turning to FIG. 1, an embodiment of a platform 100 is depicted for real time modification of a website experience for ecommerce flow optimization. In this embodiment, the platform 100 may be coupled to a website 102 that may be one of many websites 104, 106 that are similarly coupled to the platform 100. The website 102 may include various pages or modules, representing stages of a visit from a user or shopper. In this illustration, several exemplary pages or modules are illustrated but more or fewer actual pages or modules may be present for a given website. The pages or modules depicted in FIG. 1 are representative of those elements of a website that support direct interaction with a user. That is, an element of this disclosure deals with affecting user interactions with the merchant website 102 and FIG. 1 illustrates functions that are representative of these interactions. As such, the illustrated functions are not intended to be required in this form or to be an exhaustive indication of all such functions.

A landing page 110 may provide an initial entry point into the website 102 and may provide an overview of available products and services that are accessible via the website 102. The landing page 110 may also provide a place for a returning user to login in order to access various personalized pages including a settings page (not depicted).

One or more shopping pages 112 may provide individual items or services for selection by the user. The shopping pages 112 may include items as well as size and color selections for those individual items. When a user has identified a particular item of interest, the user may select the item (with optional descriptors as available) and add them to a cart. The shopping process may include a number of offers and alternatives. For example, the shopper may be provided with an incentive such as a buy one-get-one half off or a coupon for a discount on a future purchase. Such in-shopping incentives may move the shopper to increase either a purchase quantity or purchase value. However, early or frequent discount offers may overwhelm the shopper or reduce their perception of the value of regularly-priced merchandise.

After the user completes the selection process, the cart page 114 provides a listing of all items that have been selected. After accessing the cart page 114, the user may delete individual items from the cart or increase or decrease a purchase quantity for individual items to include in the purchase. Similar to the shopping page 112, the cart page 114 may also provide an opportunity to present the user with individualized opportunities, including, but not limited to, login to an account, input a loyalty card or loyalty account, continue without a login, sign up for a newsletter, or post to a social media account. As above, the more offers that are presented may distract or annoy the user, in some cases to the point of abandonment of the cart.

The cart page 114 may also allow a user to select a payment instrument for completing the purchase. For example, the user may be able to select from a credit or debit card, a digital wallet, or a payment service. When the user is known, through an account “remembered” via a cookie, via a login to an account, or by accessing a wallet account, a previously identified payment mechanism may be automatically invoked. In other cases, even when the user is known, alternative forms of payment may be provided and, as above, additional incentives may be offered to the user. For example, an incentive such as free shipping may be offered if a particular payment instrument is used or for joining a membership club.

A confirmation page 116 may provide the user with a visual confirmation, a non-volatile confirmation such as an email or print-out, or both. The confirmation page 116 allows further customization of the user interaction by providing opportunities to join a rewards program, sign up for a newsletter, send a message about the purchase to social media, etc.

In all, every page provides multiple opportunities to present a user with social media interaction, discounts and other offers, newsletters, loyalty campaigns, etc. One or more software development kits (SDK) 118, 120, 122, 124 may facilitate communication related to these opportunities between the merchant website 102 and the platform 100. In an embodiment, a particular SDK 118 may be attached to a specific function, such as the landing page 110. The SDK 118 may allow interactions between the merchant website 102 and the platform 100 so that the platform 100 can monitor user activity on that page, e.g., landing page 110. The SDK 118 may then provide data or executable code so that the landing page 110 can alter its function for a specific user. This process is discussed in more detail below. In an embodiment, each page 110, 112, 114, 116 may have a respective SDK 118, 120, 122, 124. As illustrated in FIG. 1, the landing page 110 may have an SDK 118, while the other illustrated pages 112, 114, 116 may have respective SDK equivalents 120, 122, 124. Each of the SDKs 118, 120, 122, 124 may be tailored to interact with a specific module so that appropriate data can be reported from a particular module, e.g., the cart 114 to the platform 100 and so that relevant responses can be sent from the platform 100 to each respective module.

FIG. 1 may illustrate that each page 110, 112, 114, 116 has a respective SDK modules 118, 120, 122, 124. In such an embodiment, each SDK may be customized to a different role so that messages to a particular SDK module are specific to the functions of the corresponding website page. This may allow easier updates and maintenance in that functions are broken down into smaller units and may be simpler to diagnose issues and provide updates. In a different embodiment, a single SDK 130 may be shared among all modules that operate on the merchant website 102 and that support interactions with users. In such an embodiment, while multiple functions may be grouped into one SDK, the overall cost to maintain may be lowered because functions may remain more stable over time and the website developer may have more responsibility to follow design standards to maintain compatibility.

Returning to the concept of offers and promotions made to users, the offers made to a particular user may be based on a number of factors. Some of the factors are found in data extracted during the course of the browsing/shopping experience and are related to items browsed, items selected, a length of time spent at individual pages, a number of times a particular page is visited, cart/payment page behavior, etc.

More generally, these may be referred to as shopping behavior and purchase behavior. Other information about the user's previous interactions with the website may be determined from cookies or login account data. The shopping and purchase behaviors may be update in real time as they occur, and as discussed below, used to update a machine learning engine so that a predicted outcome may be initially developed and refined for as long as the user remains on the website. Ultimately, the result of the shopping experience may be added to a database so that training may be ongoing for the machine learning engine.

Another source of information about the user is intrinsic data extracted from session data 126 including access profile information 128. Access profile information may include a user device type and operating system with additional information about screen size, interface type, processor speed, memory, and connection speed, among others. The session data may also include somewhat user-independent items such as time of day, geographic region, and referral source, among others.

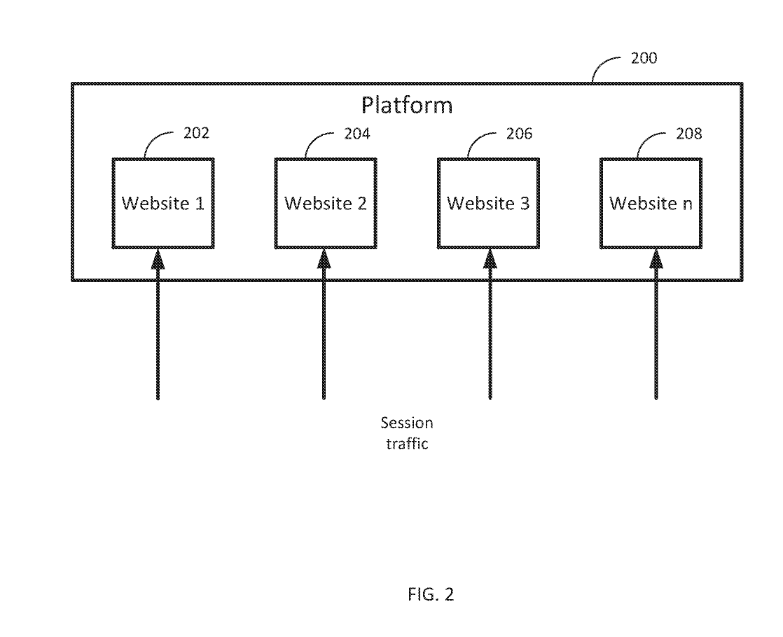

FIG. 2 is simplified and representative block diagram of another embodiment of a platform 200. As opposed to the embodiment of FIG. 1, in this embodiment the platform 200 hosts a number of merchant websites 202, 204, 206, 208. One or more SDK may not be required because the platform 200 itself has access to all activity and functions provided by each website. For simplicity sake, only the embodiment of FIG. 1 will be referred to in the following discussion even though the specific functions discussed below are relevant to both the embodiment of FIG. 1 and the embodiment of FIG. 2. For example, data access, custom modifications to web pages, etc. will be equally supported whether through an SDK with an external website or through direct access to the data provided by hosting the webpage.

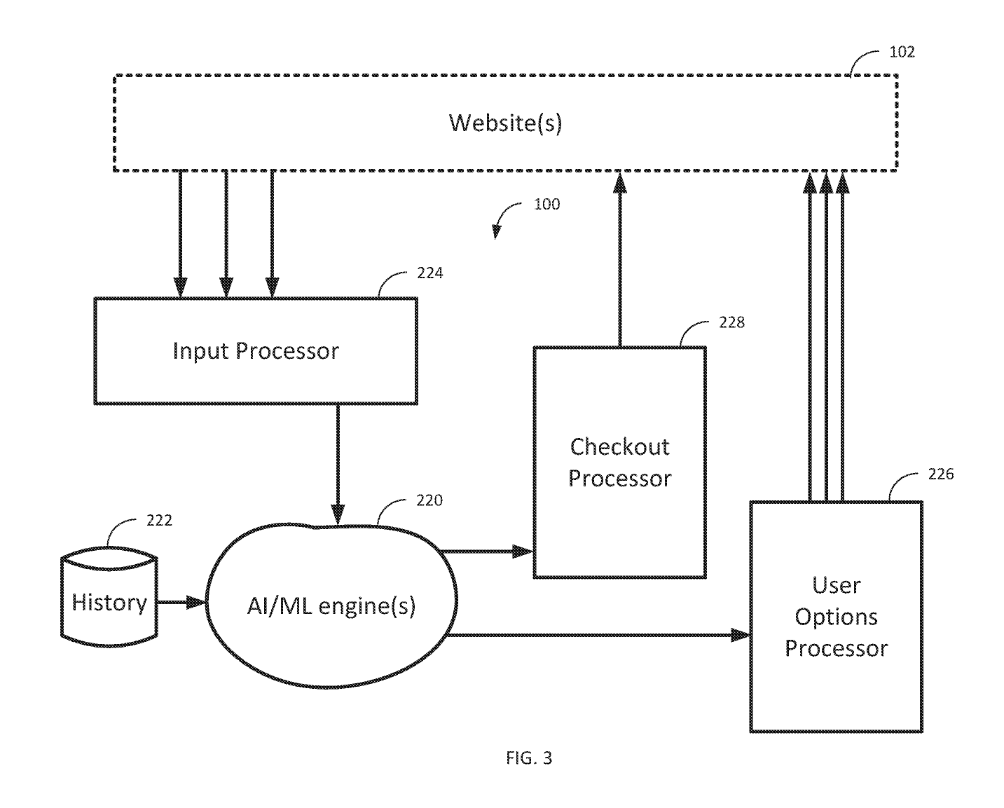

FIG. 3 is a simplified and representative block diagram of the platform 100 illustrating exemplary major functional blocks. An input processor 224 may accept objective data extracted from the access profile 128 received directly from the user session and may include, as discussed above, user device type, screen size, connection speed, etc. Other inputs may be collected using session data 126 related to user choices made during the current or a previous shopping session such as time spent on various pages, items viewed/selected, previous session data extracted from cookies, and others. The input processor 224 may receive data from multiple sources including the session data 126 and monitoring data received from one or more of the SDK modules 118, 120, 122, 124. In some embodiments, user data may be received from external sources such as a wallet account or a rewards program.

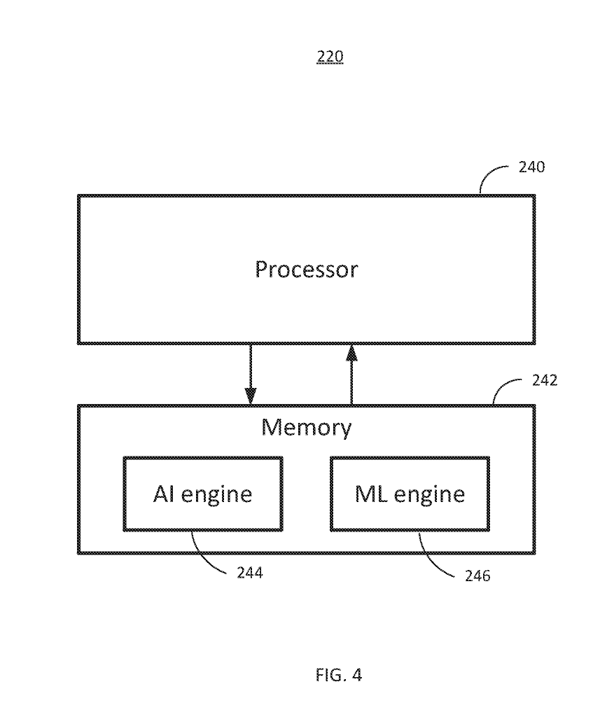

Artificial intelligence (AI) and machine learning (ML) engines 220 may receive the data from the input processor and combine that information with data received from a history database 222 in order to predict outcomes and implement changes affecting those outcomes. The AI and ML engines 220 may have separate roles and programming to accomplish different goals. Turning briefly to FIG. 4, an architecture of an exemplary AI/ML engine 220 may be illustrated. A processor 240 and memory 242 may host an AI engine 244 and an ML engine 246. In some embodiments, as illustrated, the engines 244, 246 may be implemented in software using various custom or off-the-shelf products. In other embodiments, one or both of the engines 244, 246 may be implemented in hardware. Machine learning is a particular aspect of artificial intelligence and is often associated with machine vision or other pattern matching processes. In this application, ML may be applied to the input data to predict an outcome for the shopping session. That is, for a particular set of inputs, a predicted result may be inferred. The ability to predict a result of a particular shopping experience has value in determining how and where in the purchase cycle to make offers or incentives to the user. For example, it may be determined over a large sample of user experiences that a user who is interacting with the website 102 is using an older model iPhone and is returning to look at products in the automotive accessory category will likely abandon the session 8 out of 10 times. However, through trials, it may be further determined that either free shipping or a 10% discount offered on the product page will convert the session to a sale 6 out of 10 times. Given this information, the merchant can, either directly or via an appropriate SDK, alter in real time a shopping page of the website 102 to present one or both of those offers. This can be done either as the user opens the page, via pop-up overlay windows on a current shopping page, or later, as the user is leaving the page, for example.

Returning to FIG. 3, some outcomes include a purchase, a repeat visit, a repeat purchase, abandoning the current session, abandoning a cart, abandoning a future session, or attrition (never returning to the website 102). As input data and historical data are categorized to predict an outcome by the ML engine 246, the AI engine 244 may generate offers and incentives for insertion at different points in the user session to influence the shopper to a more desirable outcome. That is, the goal is to present an offer or incentive that influences an outcome of making a purchase or a return visit as opposed to a predicted less desirable outcome such as abandoning a cart or never returning.

In an embodiment, a user options processor 226 may be used to alter the website 102 according to instructions from the AI/ML engines 220. The customizations may include offers such as a straight discount on a current purchase, buy one-get one, discounts on a future purchase, discounts on a bundle of products, increased rewards points, free shipping, and more. As discussed above, the AI/ML engines 220 may determine from current inputs a predicted outcome for a particular shopper and provide the offers to improve the actual outcome compared to the predicted outcome. In some cases, when the predicted outcome is already favorable, an offer may still be made to improve the result of a potentially already favorable outcome by encouraging an upsell, add-on, or increased quantity. In addition to offers, the AI/ ML engines may customize pages to improve the shopping experience for the user. For example, some users may be identified as being cautious buyers and as such may be given easier access to customer reviews or shown more products via “customers also viewed . . . ” links. However, other users may be identified simply as knowing what they want may be shown the product and the add-to-cart button with other elements diminished or off the initial screen. For these experiences to be implemented in real time, the user options processor 226 may generate and provide code, stylesheets, or simply data, that causes these changes to be presented to the user in real time as different pages are generated or refreshed.

While offers and customizations may be useful in moving a user to make a purchase decision, additional areas of “friction” may discourage a user from completing a transaction or from returning to the website 102. One of these areas may include the checkout process. The checkout process may include collecting personal information, getting payment data, and selecting shipping options, as well as receiving offers to join a rewards program or sign up for a newsletter. While these post-selection items typically happen after a decision to buy has been made, when a shopper, particularly a first-time shopper, becomes overwhelmed with the number of decisions and options it may create a negative impression or even cause the shopper to abandon their cart. To address this potential issue, the checkout processor 228 may affect the checkout process for a particular user session. For example, if it is understood through training that a particular category of shoppers is time sensitive, multiple input areas (e.g., bill to, ship to, payment instrument) may be combined into one page. In an opposite example, complexity may be an issue so that the individual data input areas may be displayed on separate pages with more detailed explanations. To illustrate further, some shoppers may be candidates for add-on purchases or rewards programs while other shoppers may not. In yet other embodiments, the checkout process may be tailored to the user's environment, including device-type and operating system, screen size. Some countries offer different payment options so the geographic location of the user and past-selections or explicit preferences may influence what payment instruments are offered or pre-populated. For example, a user that may prefer to enter a card number when at home on a full computer may prefer to use a payment service such as Visa Checkout when using a mobile device or when traveling. In each of these cases, the checkout processor 228 may customize executable code and install it in real time in a particular instance of the website that is serving a particular user.

The AI engine 244, the checkout processor 228, or both may continuously test alternatives to the payment process so that at any given time multiple payment flows and options may be in use. An incumbent flow may be initially selected for any of a number of reasons and used for the bulk of transactions. In parallel, one or more test payment flow alternatives may be in use at any given time. In an embodiment, as much as 10% of the total traffic may be directed to an alternate flow. In an embodiment, the users selected for an alternate flow may be chosen based on segmentation or may simply be randomly selected. In various embodiments, segmentation may be by geographic location or device type. In other embodiments, segmentation may also include known information about the user such as previous purchase volumes or product types. For example, in various embodiments, the payment options may be changed, payment types may be hidden or emphasized, the layout or order of events while interacting with a website may be changed, etc. In some cases, the merchant or website operator may control or specify some variables, for example for the sake of branding, such as font, font size, button locations or others.

When a particular test flow is shown to have an increased conversion rate, its usage rate may be increased or may even replace the current incumbent checkout process. In this fashion, constantly changing user preferences may be monitored and accommodated. Because multiple merchants may be supported by either of the architectures disclosed, or similar arrangements, the process of testing and updating payment flows may benefit from feedback from different user bases associated with variations in products, payment instruments, web styles, and branding. For example, a single merchant may not have a high enough volume of transactions or other interactions to develop accurate or meaningful segmentation of visitors. Further, single merchant may not have enough product breadth or geographic reach to have a broad range of users/site visitors to develop meaningful insights for the purpose of accurate and meaningful segmentation. Similarly, experimentally designed changes to website and checkout flows may not have enough volume reach meaningful conclusions about optimal flows, especially in view of user segmentation. That is, a single merchant, or even a merchant chain, tends to appeal to a group that is to some extent already self-selected into some aspects of a segmentation. A clothing merchant targeting young women may not have enough users who typically buy wood-working tools online to develop segmentation and flow optimization for that segment. However, a very large retailer or perhaps better, a payment processor may have access to thousands or millions of experiences across geography, product types, age, gender and more. Such access to vast amounts of user experience data and the ability to gain insights through experimentation with flows goes beyond the limits encountered by individual website operators. These insights may allow tailoring a website experience even for that wood-working shopper when visiting the clothing merchant, providing the wood-worker with a more pleasant experience and the website operator with a higher chance of closing a sale.

The merchants using such a system may benefit not only from outsourcing payment functions and the attendant reduction in complexity, lowered risk, and better compliance, but may also benefit from optimization based on a test audience that may not be accessible to a single merchant on its own. This broader base of test users may include not only local or domestic merchants but also international markets so that trends in user preferences may be identified before even moving into a particular region.

Both the user options processor 226 and the checkout processor 228 may interact with the website 102 to change the website operation to implement the changes developed by the AI/ML engines 220. The actual implementation may involve generation of user-specific code, such as JavaScript, by one of the processors 226, 228. The user-specific code may be delivered to the website 102 by an appropriate SDK 118, 120, 122, 124. In the embodiment of FIG. 2, the platform 200 may simply insert the user-specific code into the website directly. In other embodiments, alternative style sheets may be activated to present or hide graphics that are present in each webpage but only selectively presented to a user during the current session. In any of the embodiments, the AI/ML engines 220 use patterns in the input characteristics, in conjunction with known effects of offers and other customizations to update the operation of the website 102.

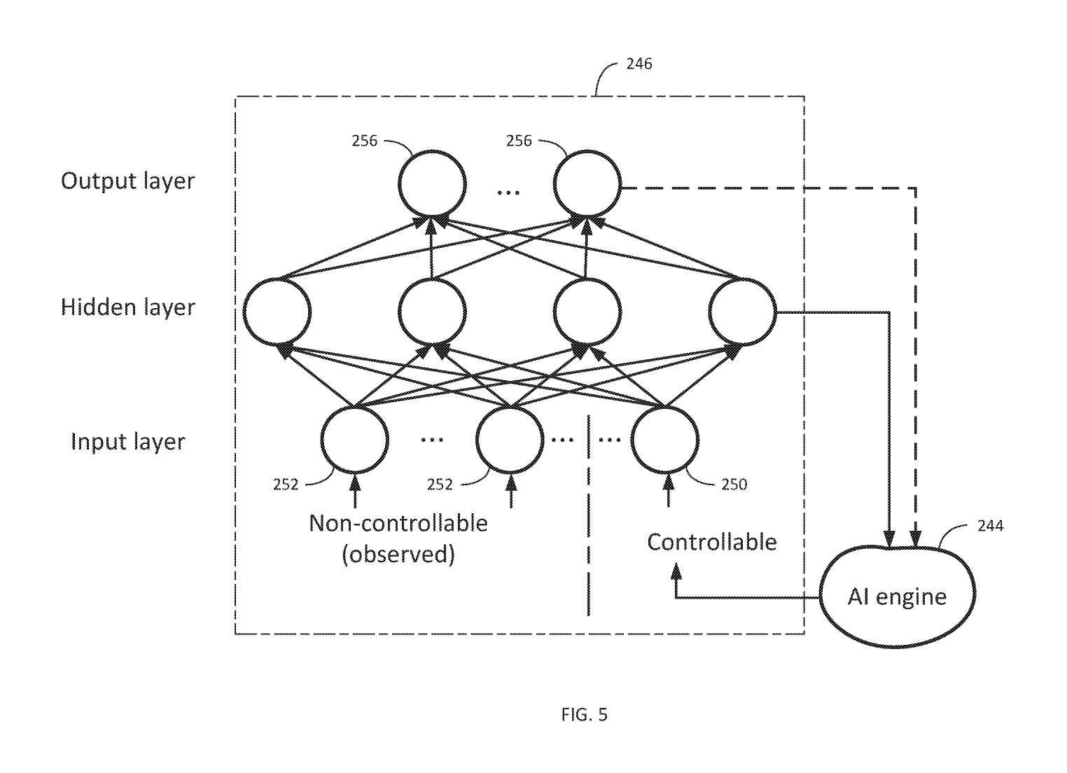

FIG. 5 depicts a typical machine learning architecture for use in an application in accordance with the current disclosure. In this illustration, using a generalized form of ML architectures, the ML engine 246 is shown with an input layer, a hidden layer, and an output layer. The input layer includes inputs 252 coupled to the input processor 224 and represent those inputs that are simply observed from actual user behavior in a current shopping session. The hidden layer includes weighted nodes that have been trained for the shopping experiences being observed. Each node of the hidden layer receives the sum of all inputs multiplied by a corresponding weight. The output layer presents various outcomes 256 based on the input values and the weighting of the hidden layer. Just as a machine learning vision system can be trained to determine when a school bus is present in an image, the ML engine 246 can be trained to analyze a likely outcome for a given set of inputs based on thousands or even millions of observations of previous shopping sessions.

As is known, during generalized training of an ML engine a dataset of inputs may be applied to an ML engine and the hidden layer weights adjusted for the known outcome associated with that dataset. As more datasets are applied, the weighting accuracy improves so that the outcome prediction is constantly refined to a more accurate result. In this case, the history database 222 may provide datasets for initial training and ongoing refining of the ML engine 246.

Additional training of the ML engine 246 may include the AI engine 244 providing additional values to one or more controllable inputs 250 so that outcomes may be observed for particular changes to the shopping and cart/payment pages. The values selected may represent different offers or alternative page elements presented at various points in the website user flow and may be generated at random or by a pseudo-random process. By adding controlled variables to the shopping process, over time, the impact can be measured and fed back into the ML engine 246 weighting to allow capture of an impact on a proposed offer or incentive. Over time, the impact of providing selected offers or incentives at different points in the sales cycle can be used to predict an outcome for a given set of observed values at inputs 252.

As shown in FIG. 5, after training is completed, data from the hidden layer may be fed to the AI engine 244 to generate values for controllable input(s) 250 for offers or page changes that may lead to a better outcome. Similarly, data from the output layer may be fed back into the AI engine 244 so that the AI engine 244 can, in an embodiment, iterate with different proposed offers in order to determine via the trained ML engine 246, what offers may be most effective in moving the user to a more desirable result.

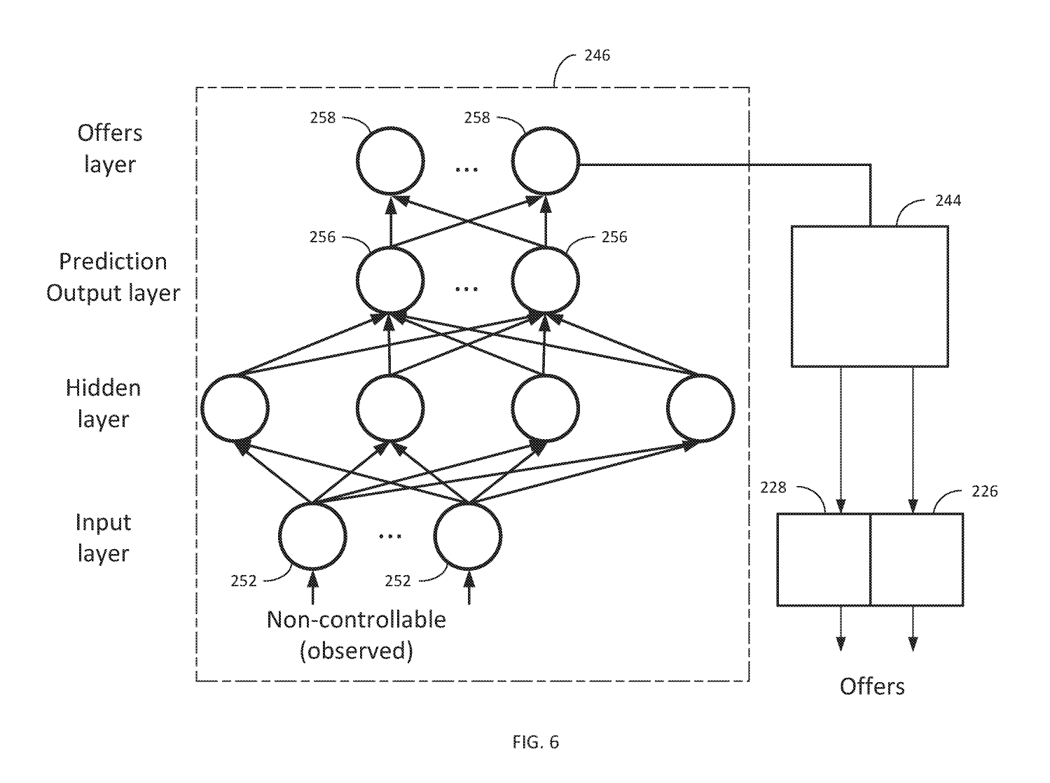

Other configurations of ML engine 246 and AI engine 244 may be built. For example, a second instance of an ML engine or an additional layer may be used to evaluate the predicted results from the observed inputs 252 in order to generate suggested offers to the AI engine 244. One such embodiment is shown in FIG. 6. As illustrated, a second output layer with outputs 258 may be used to generate the offers and incentives recommendations to the AI engine 244, which in turn, modifies the website via the appropriate SDK 118, 120, 122, 124 to present one or more offers or incentives.

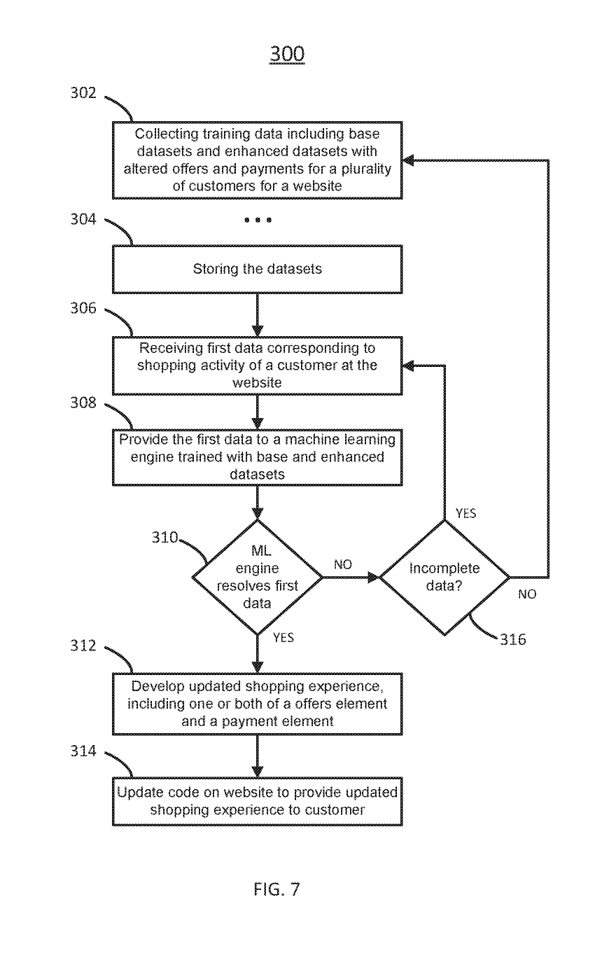

FIG. 7 is a flowchart of a method 300 of real time modification of website code. At block 302, data may be collected from one or more websites. The data may include datasets for multiple individual user interactions with the one or more websites. The datasets may include environment data such as time of day, location, website, website entry point (referral source), browser and device information, and language, among others. The datasets may also include session data such as previous session cookie data, pages visited, time on each page visited, items selected, and the number of return visits to a page, among others. Finally, the dataset may include outcome data such as items purchased, purchase volume, purchase value, cart and purchase pages activity, abandoned carts, time between page visits, etc. The datasets may be stored, for example, in a history database 222 at block 304. In an embodiment, the datasets may be used by the AI engine 244 to infer what offers or changes to the payment process may be useful in increasing the likelihood of converting a sale, of increasing the total spend, or of improving the user's return rate.

In another embodiment, the datasets may be used to train a machine learning (ML) engine 246 so that the ML engine 246 can predict an outcome based on a current set of inputs for an in-progress shopping session. The training of the ML engine 246 may be twofold. First, “natural” datasets may be collected from user sessions that follow an out-of-the-box shopping experience, which is captured from front to back and may even include follow up data about return visits. Second, “test” datasets may be collected from sessions for which the AI engine 244 causes offers or payment processes to be intentionally altered to present an experience that varies from the out-of-the-box experience. These test datasets may contain randomly generated changes to get more coverage, may contain targeted changes based on suspected effects, or may be a combination of these or others.

A block 306, first data for a current shopping session of a user may be received. The first data may include, as discussed above, device information, connection information, and real time information about the current session such as pages being visited. Since in most embodiments the website 102 will launch a unique thread to handle an individual user session, the processor 240 may similarly launch corresponding threads to support instances of the AI engine 244 and, in an embodiment, the ML engine 246.

In an embodiment, at block 308, the first data may be provided to the ML engine 246. If, at block 310, the ML engine 246 is able to resolve the first data into a credible output, then execution may follow the “yes” branch to block 312. For example, some ML engines may produce either or both of a reliability index and a certainty index which may be used to determine a level of confidence in the results. When one or both of these indices fail to reach a threshold value, the output, that is, the predicted outcome of the shopping experience may be rejected.

If the ML engine 246 fails to produce a credible output, then execution may follow the “no ” branch to block 316. There may be more than one reason that output data is not deemed credible. One reason may be incomplete information in the first data, such as only the platform is known, but no other information is available. In this circumstance, execution may return to block 306, where more information related to the user platform and activity may be developed. Another reason may be that the first data may not resolve to a known output state in that the input conditions were not previously trained. In this event, the first data, and any subsequent output data may be fed back to the training database 222, for example, at block 302 so that the ability of the ML engine 246 to predict outcomes for shopping experiences may be improved over time.

When, at block 310, the ML engine 246 resolves to a credible output such that one or both quality metrics, if used, are met, execution may continue at block 312. There, using the output of the ML engine 246, the AI engine 244 may formulate an updated shopping experience for the user. The AI engine 244 may use heuristics to add, remove, or change the offers presented to a user during the shopping phase and for how to modify the cart and checkout processes for the payment phase. The heuristics may include data developed from selective testing used to select different offers. In an embodiment, these changes to the website may selected based on the best match based on the historical data. That is, the AI engine 244 may be able to inference simply from a predicted outcome as to what changes to make to the website to influence a better outcome.

In another embodiment, for example using the architecture of FIG. 6, the ML engine 246 may simply output offers for the AI engine 244 to implement via the user options processor 226, the checkout processor 228, or both. Because the ML engine 246 may be trained to suggest effective website changes at the offers layer, the AI engine 244 may simply translate the output of the ML engine 246 into commands to the processors 226, 228. For example, the AI engine 244 may simply send instructions to add a 10% discount offer to the user at the shopping page 112. In another example, when the user is recognized via a login or a cookie, multiple instructions may be made that cause a welcome message to be displayed on the landing page 110 and for the shipping and payment data to be pre-populated on the cart/checkout page 114.

In yet another embodiment using the architecture of FIG. 5, the website changes may be selected by feeding the proposed changes back into the ML engine 246 and re-evaluating the output for a new expected outcome. In this embodiment, many iterations of proposed changes may be input into the ML engine 246 and the outcomes monitored to determine an input combination that provides, if not the best predicted outcome, at least an acceptable predicted outcome. The AI engine 244 may then send instructions for website updates when either an acceptable input set is found or there is no more time for continued modeling.

After the AI engine 244 has selected changes to be implemented on the website 102, at block 314 the actual code updates may be made via the user options processor 226, checkout processor 228, or both. As discussed above, the changes may be made by directly inserting code into various pages on the website 102. That is, particular code snippets may be added into the code of a particular page. In another embodiment, stylesheet changes may be made that either display or hide various offers or payment options. These changes may be made via the respective SDKs 118, 120, 122, 124 in the embodiment of FIG. 1 or via direct manipulation in the embodiment of FIG. 2. Other specific techniques for real time updates to web pages will be apparent to a practitioner based on the implementation language, type of processor 240, and even the user's browser type and platform.

A technical effect of the techniques disclosed is real time changes in processor code hosting a website 102 so that each user is presented with a unique experience and unique user interfaces based on observed similarities to previous sessions and knowledge developed by experimental changes to other sessions. The system uses artificial intelligence and machine learning to predict the user interface and user experience which will have the desired result (higher sales, higher user satisfaction, etc.) for a specific user based on past user experiences.

A website 102 using the disclosed system and method benefits both users and website operators. The uniquely customized server code presents a user with information and offers that are particularly useful and helpful, so that the user satisfaction is improved. The website owner/operator benefits from increased sales, increased return visits and overall increases in user satisfaction. The large sample of user activity provides ongoing training for the AI engine 244 and ML engine 246 so that changes in user shopping patterns can be constantly fed back into the system while he customized code activated or installed in real time allows instant reaction to those changes.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A system for ecommerce flow optimization comprising:
a processor and memory hosting an artificial intelligence (AI) engine;
an input processor coupled to the processor and memory, the input processor capturing data from a website of a merchant, the data corresponding to shopping and purchase behavior of an interaction of a user with the website;
a database coupled to the processor and memory, the database storing historical shopping and purchase data for a plurality of users over a plurality of merchants;
a user options processor coupled to the processor and memory, the user options processor providing real time changes to the merchant website on a per-user basis, the real time execution changes to the merchant website affecting at least one offer made to the user; and
a checkout processor coupled to an output of the AI engine that develops a payment process for a particular transaction based on the historical shopping and purchase data, the checkout processor providing real-time execution changes to the website of the merchant for the user.

2. The system of claim 1, wherein the input processor captures user landing page information including a user identifier and a device type of the user.

3. The system of claim 1, wherein the input processor captures shopping behavior including sites visited, selections, cart updates and abandoned carts.

4. The system of claim 1, wherein the input processor captures shopper personal information including purchase instrument and purchase value.

5. The system of claim 1, wherein the input processor captures merchant profile data including merchant category and user behavior.

6. The system of claim 1, further comprising a machine learning engine that develops correlations between input conditions, wherein the machine learning engine reweights input conditions based on the historical shopping and purchase data from the database.

7. The system of claim 6, wherein the machine learning engine predicts an outcome of the user interaction with the website based on a set of values of the input conditions.

8. The system of claim 6, wherein the machine learning engine predicts the outcome of the user interaction with the website based further on input variables set by the user options processor and the checkout processor.

9. The system of claim 1, further comprising a sales offer function that generates code that is inserted at the merchant website to vary a user shopping experience.

10. The system of claim 9, further comprising a random number generator, wherein the sales offer function generates code based on a random number received via the random number generator to vary the user shopping experience in a random fashion.

11. The system of claim 9, wherein the sales offer function varies one or more of a guest-only checkout, a discount on a current purchase, a discount on a future purchase, and a reward for providing personal information.

12. A method of real time modification of website code using a server and memory hosting an artificial intelligence (AI) engine, the method comprising:
storing a dataset corresponding to shopping and purchase behavior of a plurality of users for a plurality of merchant websites;
receiving, via an input processor coupled to the server and memory, first data corresponding shopping activity of a user at a first merchant website;
developing a shopping experience for the user based on an analysis by an AI engine of the dataset in view of the first data; and
updating executable code at the first merchant website in real time to adopt the developed shopping experience for the user.

13. The method of claim 12, wherein developing the shopping experience comprises providing the dataset to a machine learning tool that correlates the first data to a predicted outcome.

14. The method of claim 13, wherein the shopping experience includes a payment element and an offers element.

15. The method of claim 14, further comprising updating at least one of the payment element and the offers element to move the predicted outcome to a desired outcome based on the first data and the predicted outcome.

16. The method of claim 15, wherein the AI engine receives feedback from machine learning tool indicating a preferred configuration for the at least one of the payment element and the offers element to move the predicted outcome to the desired outcome.

17. The method of claim 14, further comprising collecting training data using the dataset and an intentionally altered payment element to observe an actual outcome.

18. The method of claim 14, further comprising selectively providing multiple payment flows via the payment element to determine a user-preferred payment flow.

19. The method of claim 12, wherein updating executable code at the first merchant website in real time comprises updating executable code at the first merchant website via a software developer kit (SDK) installed at the first merchant website and in communication with the server and memory.

20. The method of claim 12, wherein updating executable code at the first merchant website comprises updating executable code supporting operation of the first merchant website on the server and memory.
